(19) United States
(12) Patent Application Publication
(10) Pub. No.: US 2024/0178689 A1
(43) Pub. Date: May 30, 2024

(54) POWER SUPPLY INCLUDING MUTLIPLE CONNECTED INVERTERS

(71) Applicant: MILWAUKEE ELECTRIC TOOL CORPORATION, Brookfield, WI (US)

(72) Inventor: Mahesh M. Swamy, Gurnee, IL (US)

(21) Appl. No.: 18/525,666

(22) Filed: Nov. 30, 2023

Related U.S. Application Data
(60) Provisional application No. 63/385,419, filed on Nov. 30, 2022.

(51) Int. Cl. H02J 7/00; H02J 7/02; H02J 7/34; H02M 7/797; H02M 7/81

(52) U.S. Cl. CPC H02J 7/0063; H02J 7/0013; H02J 7/0042; H02J 7/02; H02J 7/34; H02M 7/797; H02M 7/81

(57) ABSTRACT

A power supply includes a first inverter and a second inverter. The second inverter is connected in series with the first inverter in an open delta configuration. The first inverter is configured to be powered by a first battery and to output a first power signal having a first phase angle. The second inverter is in electrical communication with the first inverter and configured to be powered by a second battery and to output a second power signal having a second phase angle. The power supply also includes a controller configured to control a phase difference between the first phase angle and the second phase angle to control a magnitude of a combined output voltage of the first inverter and the second inverter.

### RELATED APPLICATIONS

This application claims the benefit of U.S. Provisional Patent Application No. 63/385,419, filed Nov. 30, 2022, the entire content of each of which is hereby incorporated by reference.

### SUMMARY

A portable power platform may be powered by a core Li-Ion battery bank and/or individual battery packs. The portable power platform may include multiple connected inverters and be configured to power corded tools or use Li-Ion battery pack chargers to charge corresponding battery packs. The portable power platform can be configured to charge, for example, 12V, 18V and 80V battery packs. The power requirements of 3-phase alternating current (AC) loads may also be satisfied by using the connected battery powered inverters described herein to generate three phases of power.

Embodiments described herein provide an arrangement of multiple connected battery powered inverters that can be configured to generate a three-phase power output and/or a single-phase power output. The connected battery powered inverters may be arranged in a wye configuration and or an open delta configuration via the manipulation of one or more switches. Each of the connected battery powered inverters may be used to charge the battery of another connected battery powered inverter.

In some aspects, the techniques described herein relate to a power supply including an alternating-current (AC) output, a first inverter configured to be powered by a first battery and to provide a first power signal having a first phase angle to the AC output, a second inverter configured to be powered by a second battery and to provide a second power signal having a second phase angle to the AC output, and a controller electrically connected to the first inverter and the second inverter. The controller is configured to control the first inverter to adjust the first phase angle and control the second inverter to adjust the second phase angle to adjust a magnitude of an output voltage at the AC output.

In some aspects, the techniques described herein relate to a power supply including an alternating-current (AC) output, a first inverter configured to be powered by a first battery and to provide a first power signal to the AC output, a second inverter configured to be powered by a second battery and to provide a second power signal to the AC output, a third inverter configured to be powered by a third battery and to output a third power signal to the AC output, a switching arrangement connected between the first inverter, the second inverter, and the third inverter, and a controller electrically connected to the first inverter, the second inverter, and the third inverter. The controller is configured to control the switching arrangement to switch the first inverter, the second inverter, and the third inverter between an open delta configuration including the first inverter and the second inverter, and a wye configuration including the first inverter, the second inverter, and the third inverter.

In some aspects, the techniques described herein relate to a method of controlling a power supply including a first inverter, a second inverter, and a third inverter connected to an alternating-current (AC) output. The method includes determining, using a controller, an output requirement of the power supply, connecting, using a switching arrangement, the first inverter and the second inverter in an open delta connection when the output requirement is a higher voltage and connecting, using the switching arrangement, the first inverter, the second inverter, the third inverter in a wye connection when the output requirement is a lower voltage.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Other aspects of the embodiments will become apparent by consideration of the detailed description and accompanying drawings.

### BRIEF DESCRIPTION OF THE DRAWINGS

FIG. 1A illustrates a perspective view of a portable power supply device, according to embodiments described herein.

FIG. 1B illustrates a battery assembly including a plurality of battery cells, according to embodiments described herein.

FIG. 2 illustrates a control system for the portable power supply device of FIG. 1

incorporating a plurality of connected battery powered inverters, according to embodiments described herein.

FIG. 3 illustrates a schematic of an output power conversion unit, according to embodiments described herein.

FIG. 4A illustrates a schematic of two inverters connected in parallel, according to embodiments described herein.

FIG. 4B illustrates a schematic of two inverters connected in series, according to embodiments described herein.

FIG. 4C illustrates a schematic of two inverters connected in an open delta configuration, according to embodiments described herein.

FIG. 4D illustrates a schematic of three inverters connected in a wye configuration, according to embodiments described herein.

FIG. 5 illustrates a flowchart for controlling a plurality of connected battery pack powered inverters, according to embodiments described herein.

### DETAILED DESCRIPTION

Battery powered inverters can be used to provide portable AC power at construction sites and other residential and industrial locations. In many applications, a user may need to power more than one AC powered load, thus requiring multiple battery powered inverters. By using multiple, low power inverters driven by independent batteries or battery packs, multiple AC loads can be supported without causing unwanted ripple currents in the batteries as would occur in a single-battery, multiple-inverter system. Additionally, by using multiple connected, independent battery powered inverters, three-phase power can be produced safely from a portable power supply.

In some examples, an inverter is an inverter circuit including a transformer. A DC signal flows through a primary winding, and a relay switch is switched back and forth to allow current to flow back to the DC source following one of two paths. This change of direction in current causes the current flowing through the primary winding to alternate, thereby producing alternating current (AC) in a secondary circuit. In some examples, an inverter is an inverter circuit including a plurality of switches (e.g., FETs, MOSFETs) arranged in a bridge formation (e.g., an H-bridge formation). The plurality of switches are controlled using PWM signals to produce an alternating current on an output side of the bridge formation. In some examples, an inverter includes a controller for control of electronic components (e.g., switches) and for data communications with other circuits (e.g., synchronization and fault communication between inverters). In some examples, the inverter is configured to invert an input DC signal received on DC leads of the inverter into an AC signal on the AC leads of the inverter. In some examples, the inverter is a bidirectional inverter configured to invert a DC signal received on the DC leads of the inverter into an AC signal on the AC leads of the inverter, and to convert an AC signal received on the AC leads of the inverter into a DC signal on the DC leads of the inverter.

It should be understood that although certain drawings illustrate hardware and software located within particular devices, these depictions are for illustrative purposes only. Functionality described herein as being performed by one component (e.g., a controller) may be performed by multiple components (e.g., multiple controllers) in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors.

Additionally, hardware and software components discussed herein may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Although embodiments described herein can be applied to, performed by, or used in conjunction with a variety of high-power devices, embodiments are described primarily with respect to connected battery powered inverters for use with a portable power supply system.

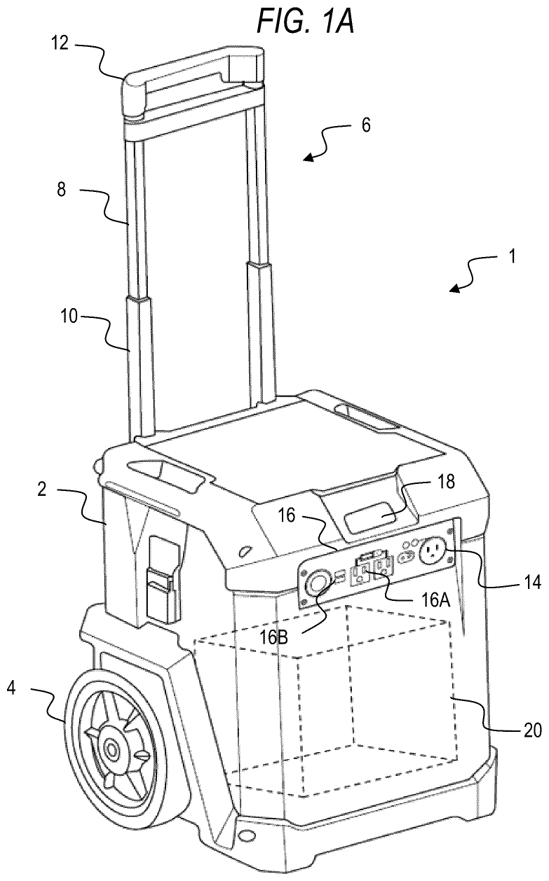

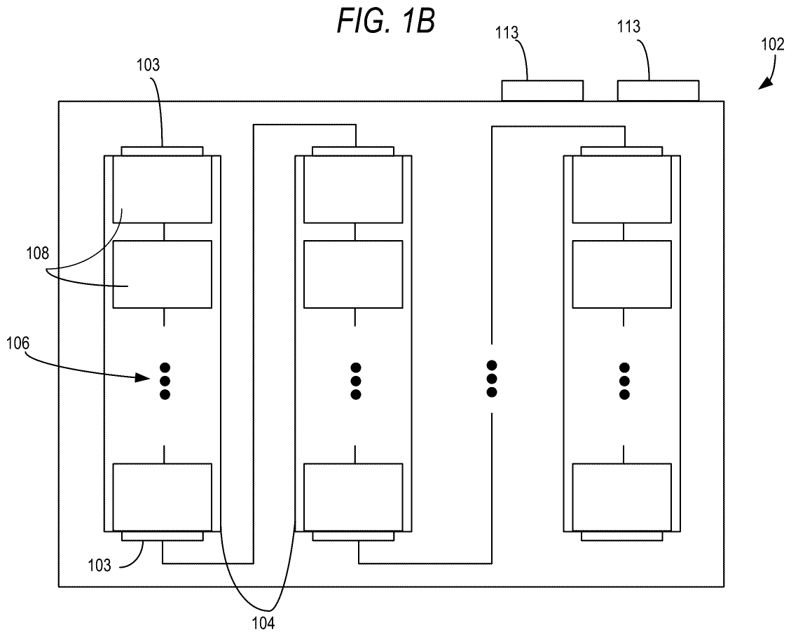

FIG. 1A illustrates a portable power supply device or power supply 1. The power supply 1 includes, among other things, a housing 2. In some embodiments, the housing 2 includes one or more wheels 4 and a handle assembly 6. In the illustrated embodiment, the handle assembly 6 is a telescoping handle movable between an extended position and a collapsed position. The handle assembly 6 includes an inner tube 8 and an outer tube 10. The inner tube 8 fits inside the outer tube 10 and is slidable relative to the outer tube 10. The inner tube 8 is coupled to a horizontal holding member 12. In some embodiments, the handle assembly 6 further includes a locking mechanism to prevent inner tube 8 from moving relative to the outer tube 10 by accident. The locking mechanism may include notches, sliding catch pins, or another suitable locking mechanism to inhibit the inner tube 8 from sliding relative to the outer tube 10 when the handle assembly 6 is in the extended position and/or in the collapsed position. In practice, a user holds the holding member 12 and pulls upward to extend the handle assembly 6. The inner tube 8 slides relative to the outer tube 10 until the handle assembly 6 locks in the extended position. The user may then pull and direct the power supply 1 by the handle assembly 6 to a desired location. The wheels 4 of the power supply 1 facilitate such movement.

The housing 2 of power supply 1 further includes a power input unit 14, a power output unit 16, and a display 18. The power input unit 14 may include multiple electrical connection interfaces configured to receive power from an external power source. In some embodiments, the external power source is a DC power source. For example, the DC power source may be one or more photovoltaic cells (e.g., a solar panel), an electric vehicle (EV) charging station, or any other DC power source. In some embodiments, the external power source is an AC power source. For example, the AC power source may be a conventional wall outlet, such as a 120 V outlet or a 240 V outlet, found in North America. As another example, the AC power source may be a conventional wall outlet, such as a 220V outlet or 230V outlet, found outside of North America. In some embodiments, the power input unit 14 is replaced by or additionally includes a cable configured to plug into a conventional wall outlet. In some embodiments, the power input unit 14 further includes one or more devices, such as antennas or induction coils, configured to wirelessly receive power from an external power source. The power received by the power input unit 14 may be used to charge a core battery, or internal power source 20, disposed within the housing 2 of power supply 1. In some embodiments, the internal power source includes multiple battery cores that can be operated collectively (e.g., in series, in parallel, etc.) or independently (e.g., each battery core provides an independent voltage and current output). In some embodiments, the internal power source 20 is replaced or supplemented by one or more battery packs (e.g., power tool battery packs) that can be used to provide output power from the power supply 1. The battery packs can be operated collectively (e.g., in series, in parallel, etc.) or independently (e.g., each battery pack provides an independent voltage and current output).

The power received by the power input unit 14 may also be used to provide power to one or more devices connected to the power output unit 16. In the embodiment shown, the power output unit 16 includes one more power outlets connected to multiple battery powered inverters in electrical communication with one another. In the illustrated embodiment, the power output unit 16 includes a plurality of AC power outlets 16A and DC power outlets 16B. It should be understood that number of power outlets included in the power output unit 16 is not limited to the power outlets illustrated in FIG. 1A. For example, in some embodiments of the power supply 1, the power output unit 16 may include more or fewer power outlets than the power outlets included in the illustrated embodiment of power supply 1.

In some embodiments, the power output unit 16 is configured to provide power output by the internal power source 20 to one or more peripheral devices. In some embodiments, the power output unit 16 is configured to provide power provided by an external power source directly to one or more peripheral devices. The one or more peripheral devices may be a smartphone, a tablet computer, a laptop computer, a portable music player, a power tool, a power tool battery pack, a power tool battery pack charger, or the like. The peripheral devices may be configured to receive DC and/or AC power from the power output unit 16.

In some embodiments, the DC power outlets 16B include one or more receptacles for receiving and charging power tool battery packs. In such embodiments, power tool battery packs received by, or connected to, the battery pack receptacles 16B are charged with power output by the internal power source 20 and/or power received directly from the external power source. In some embodiments, power tool battery packs connected to the battery pack receptacles 16B are used to provide power to the internal power source 20 and/or one or more peripheral devices connected to outlets of the power output unit 16. In some embodiments, the power output unit 16 includes tool-specific power outlets. For example, the power output unit may include a DC power outlet used for powering a welding tool.

The display 18 is configured to indicate a state of the power supply 1 to a user, such as state of charge of the internal power source 20 and/or fault conditions. In some embodiments the display 18 includes one or more light-emitting diode (“LED”) indicators configured to illuminate and display a current state of charge of internal power source 20. In some embodiments, the display 18 is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. In other embodiments, the power supply 1 does not include a display.

FIG. 1B shows a battery pack or battery core 102 including a plurality of battery assemblies 104 connected in series (e.g., internal power source 20 in FIG. 1). The plurality of batteries may vary in quantity from application to application (illustrated in FIG. 1B as an ellipse 106). For example, the battery core 102 may include 4 batteries, 5 batteries, 10 batteries, etc., connected in series via their terminals 103. Each of the batteries 104 may include a plurality of cells 108. The plurality of cells 108 may vary from application to application (illustrated in FIG. 1B as an ellipses 106). For example, each battery 104 may include 10 cells, 12 cells, 20 cells, etc. The battery core 102 also includes terminals 113 configured to deliver current to a load (not shown) via a conductor when connected to the load via the conductor.

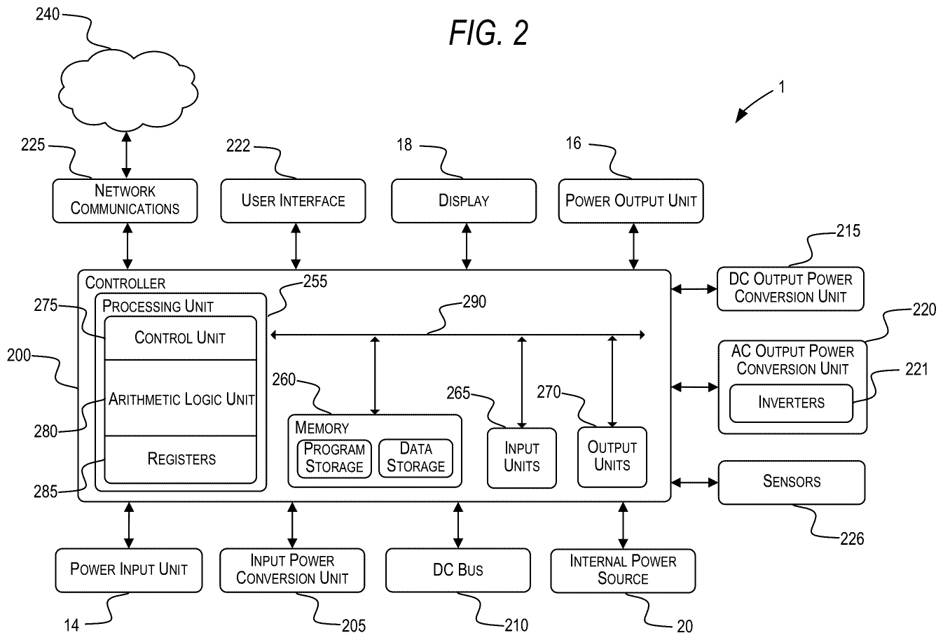

FIG. 2 is a generalized schematic illustration of the controller 200 included in power supply 1. A controller similar to controller 200 may also be included in the inverters described herein. The controller 200 is electrically and/or communicatively connected to a variety of modules or components of the power supply 1. For example, the controller 200 may be connected to the power input unit 14, the power output unit 16, the display 18, and the internal power source 20. Persons skilled in the art will recognize that electrical and/or communicative connection between the controller 200 and the internal power source 20 can include electrical and/or communicative connections between the controller 200 and components included in the internal power source 20, such as, but not limited to the plurality of subcores of the internal power source 20 and components included therein, such as battery cells and subcore monitoring circuits.

The controller 200 is additionally electrically and/or communicatively connected to an input power conversion unit 205, a DC bus 210, a DC output power conversion unit 215, and an AC output power conversion unit 220 including a plurality of connected battery powered inverters 221 (e.g., bidirectional inverters), a user interface 222, a network communications module 225, and a plurality of sensors 226.

The network communications module 225 is connected to a network 240 to enable the controller 200 to communicate with peripheral devices in the network, such as a smartphone or a server. The sensors 226 may include, for example, one or more voltage sensors, one or more current sensors, one or more temperature sensors, and/or one or more additional sensors used for measuring electrical and/or other characteristics of the power supply 1. Each of the sensors 226 generates one or more output signals that are provided to the controller 200 for processing and evaluation. The user interface 222 is included to provide user control of the power supply 1. The user interface 222 can include any combination of digital and analog input devices required to achieve a desired level of control for the power supply 1. For example, the user interface 222 may include a plurality of knobs, a plurality of dials, a plurality of switches, a plurality of buttons, or the like. In some embodiments, the user interface 222 is integrated with the display 18 (e.g., as a touchscreen display).

The controller 200 includes combinations of hardware and software that are operable to, among other things, control the operation of the power supply 1, communicate over the network 240, receive an input from a user via the user interface 222, provide information to a user via the display 18, etc. For example, the controller 200 includes, among other things, a processing unit 255 (e.g., a microprocessor, a microcontroller, an electronic processor, an electronic controller, or another suitable programmable device), a memory 260, input units 265, and output units 270. The processing unit 255 includes, among other things, a control unit 275, an arithmetic logic unit (“ALU”) 280, and a plurality of registers 285 (shown as a group of registers in FIG. 2), and is implemented using a known computer architecture (e.g., a modified Harvard architecture, a von Neumann architecture, etc.). The processing unit 255, the memory 260, the input units 265, and the output units 270, as well as the various modules or circuits connected to the controller 200 are connected by one or more control and/or data buses (e.g., common bus 290). The control and/or data buses are shown generally in FIG. 2 for illustrative purposes. Although the controller 200 is illustrated in FIG. 2 as one controller, the controller 200 could also include multiple controllers configured to work together to achieve a desired level of control for the power supply 1. As such, any control functions and processes described herein with respect to the controller 200 could also be performed by two or more controllers functioning in a distributed manner.

The memory 260 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The processing unit 255 is connected to the memory 260 and is configured to execute software instructions that are capable of being stored in a RAM of the memory 260 (e.g., during execution), a ROM of the memory 260 (e.g., on a generally permanent basis), or another non-transitory computer readable medium such as another memory or a disc. Software included in the implementation of the power supply 1 and controller 200 can be stored in the memory 260 of the controller 200. The software includes, for example, firmware, one or more applications, program data, filters, rules, one or more program modules, and other executable instructions. The controller 200 is configured to retrieve from the memory 260 and execute, among other things, instructions related to the control processes and methods described herein. In other embodiments, the controller 200 includes additional, fewer, or different components.

During operation of the power supply 1, the controller 200 is configured to monitor voltage, current, and/or other signals received from the various components described above. For example, the controller 200 is configured to monitor voltage signals received from the internal power source 20 when the internal power source 20 is charged by an external power source connected to the power input unit 14. As another example, the controller 200 is configured to monitor voltage signals received from the internal power source 20 when the internal power source 20 provides power to one or more peripheral devices connected to the power output unit 16. More generally, the controller 200 is configured to monitor and/or control power flow to and from the above-described components of power supply 1 that are electrically and communicatively coupled to the controller 200.

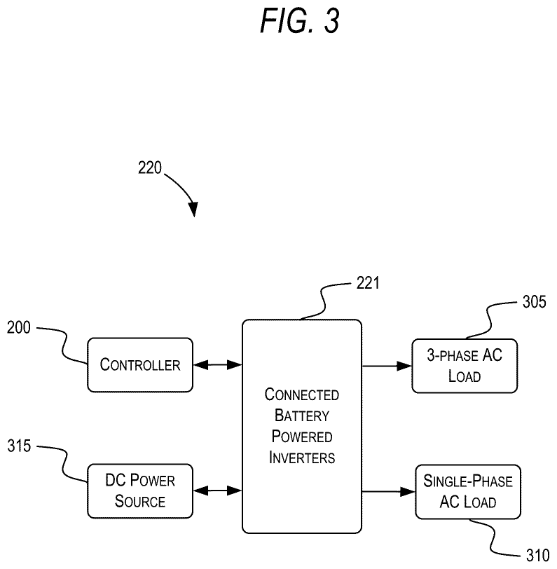

FIG. 3 illustrates the AC output power conversion unit 220 wherein the connected battery powered inverters 221 are used as a power conditioning circuit for both a three-phase AC load 305 and a single-phase AC load 310. In one example, the battery powered inverters 221 are bidirectional inverters. The connected battery powered inverters 221 may include two independent inverters connected with one another. In some embodiments, the connected battery powered inverters 221 may include three or more independent inverters connected to one another. In some examples, an output of a first inverter is connected to an input of a second inverter. In other examples, the inputs of a first inverter, a second inverter, and a third inverter as connected via a neutral wire. In some embodiments, the connected battery powered inverters 221 may include only a single inverter. As will be described in greater detail below, the connected battery powered inverters 221 can be used cooperatively to power a three-phase AC load 305 or a single-phase AC load 310.

Each of the connected battery powered inverters 221 may be driven by a DC power source 315, such as the internal power source 20, a battery pack (e.g., a power tool battery pack), or a group of independent batteries or battery packs dedicated to and independently driving each of the battery powered inverters 221. In embodiments including a group of independent batteries or battery packs dedicated to each of the battery powered inverters 221, each battery or battery pack may be charged independently, according to its state of charge, by one of the other inverters (i.e., bidirectional inverters) of the connected battery powered inverters 221. In some embodiments, a group of independent batteries or battery packs may be charged simultaneously from a single inverter.

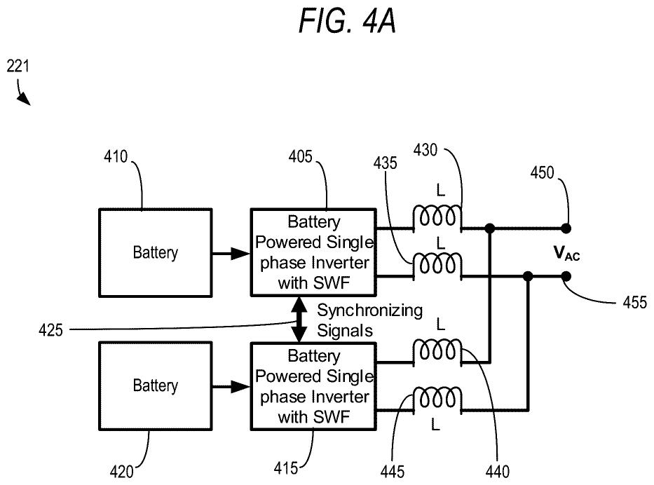

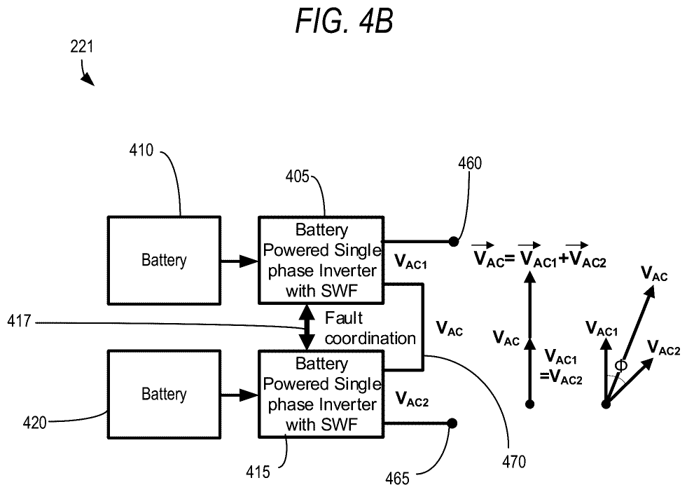

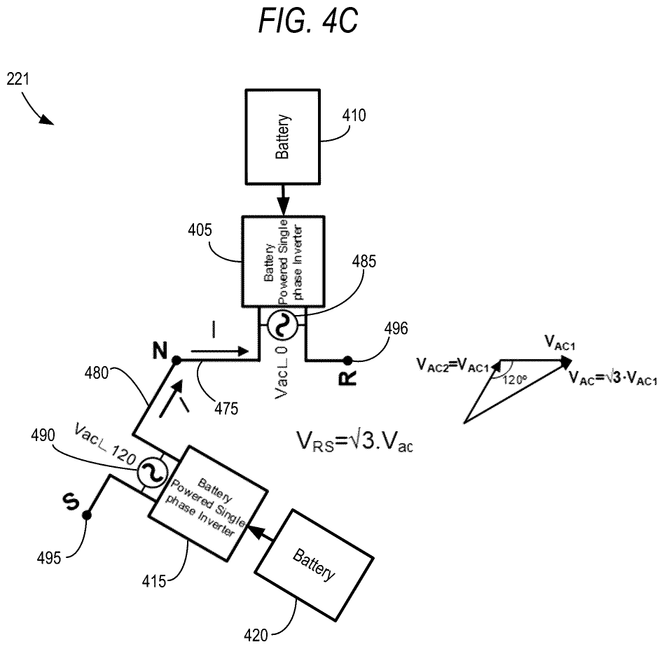

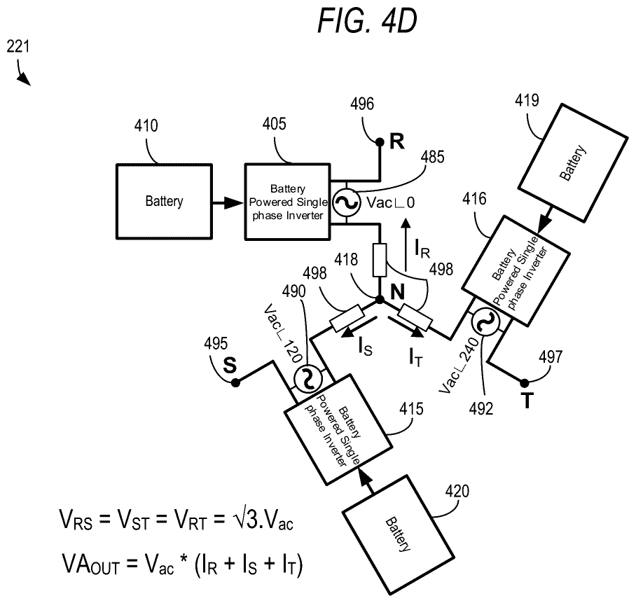

FIG. 4A illustrates a schematic of two inverters connected in parallel. This type of configuration may be desirable for supporting a load with a high current requirement. A first inverter 405 is powered by a first battery 410, and a second inverter 415 is independently powered by a second battery 420. Specifically, in the embodiment shown, the first battery pack 410 may be configured to provide power only to the first inverter 405, and the second battery pack 420 may be configured to provide power only to the second inverter 415. In some embodiments, the first battery 410 and the second battery 420 are individual battery cores (e.g., of internal power source 20) or battery packs that are removably coupled to the power supply 1. One or more synchronization signals 425 (e.g., a pulse width modulation [PWM] synchronization signal) is communicated between the inverters 405, 415 (e.g., from a controller of the first inverter 405 to a controller of the second inverter 415, via a data communication line) to ensure that there is no difference in phase angle between the two inverters 405, 415, and to prevent circulation of current from one inverter to the other. Current limiting inductors 430, 435, 440, and 445 are located on the output leads of the inverters 405, 415 to further mitigate current circulation. Fault signals may also be communicated between the inverters 405, 415 (e.g., from a controller of the first inverter 405 to a controller of the second inverter 415, via a data communication line) to ensure that a healthy inverter does not start feeding into a fault of a faulty inverter. If the output of the inverters 405, 415 are properly synchronized (e.g., so that no current circulation occurs), the resultant power signal appearing at the output leads 450, 455 of the connected battery powered inverters 221 carries the combined current of the connected battery powered inverters 221.

FIG. 4B illustrates a schematic of the first inverter 405 and the second inverter 415 connected in series. Specifically, in the embodiment shown, and output of the first invert 405 is connected to an input lead of the second inverter 415, such that a signal output by the first inverter 405 is communicated to the second inverter 415. Inverters may be connected in this manner to support a load with a higher voltage requirement. In this configuration, as with the parallel configuration shown in FIG. 4A, the first and second inverters 405, 415 are configured to communicate faults to one another via a fault coordination signal 417. If the output voltages V_{AC1} and V_{AC2} of the two inverters 405, 415 do not have any phase difference between them, then the output of the series inverters 405, 415 is the sum of the two output voltages. Because there is no difference in phase angle between V_{AC1} and V_{AC2} in FIG. 4B, the combined voltage has value of V_{AC1}+V_{AC2}. If, however, there is a difference in phase angle, ϕ, between V_{AC1} and V_{AC2} in FIG. 4B, the combined voltage has value equal to the vector sum of the two output voltages. Further, if the load current is common to both inverters, as it is in the embodiment shown in FIG. 4B, there is no need for a circulating current limiting inductor.

Applying similar principles as the inverter arrangement described above with respect to FIG. 4B, the first and second inverters 405, 415 may also be connected in, for example, an open delta arrangement, as illustrated in FIG. 4C. In the embodiment shown in FIG. 4C, a lead 475 of the first inverter 405 is connected to a lead 480 of the second inverter 415. A phase angle of an output AC voltage signal 485 of the first inverter 405 and a phase angle of an output AC voltage signal 490 of the second inverter are configured, for example, to be 120 degrees apart. This will yield a combined line-line voltage of:

V_{RS}=\sqrt{3}·V_{AC} (1)

This voltage will appear between the S terminal 495 and R terminal 496 of the inverters 221. However, the voltage at the independent leads of each inverter 405, 415 (V_{AC1}, V_{AC2}, respectively) need not be the same, depending on the desired load voltage. Any phase difference between the two inverters 405, 415 will result in a load voltage which is the vector sum of the two voltages. The vector sum of the outputs of the first and second inverters 405, 415 will have a magnitude that depends on the phase between the two voltage vectors and the angle between them. This vector sum voltage can be calculated or determined as:

V_{AC}=\sqrt{V_{AC1}²+V_{AC2}²+2·V_{AC1}·V_{AC2}·cos φ} (2)

Where ϕ is the phase shift or phase difference between the output voltage waveforms, V_{AC1} and V_{AC2}.

In some embodiments, the respective phase angles of the first and second inverters 405, 415 may be controlled by the controller 200 to meet voltage requirements of a connected single-phase AC load 310 according to equation (2). For example, the controller 200 may detect or receive the voltage requirements of the connected single-phase AC load 310 and use a PWM signaling control scheme (e.g., a regulated PWM duty cycle and/or PWM frequency) to adjust the phase angle of the output AC voltage signal 485 of the first inverter 405 with respect to the phase angle of the output AC voltage signal 490 of the second inverter 415.

FIG. 4D illustrates an embodiment of the connected battery powered inverters 221 of FIG. 4C but including a third independent inverter 416. A lead of the first inverter 405 is connected to a lead of the second inverter 415. A lead of the third inverter 416 is connected to the lead of the first inverter 405 and to the lead of the second inverter 415, thereby configuring the connected battery powered inverters 221 in a wye configuration. A neutral wire 418 extends from the connection of the leads of the first inverter 405, the second inverter 415, and the third inverter 416. Like the first inverter 405 and the second inverter 415, the third inverter 416 is powered by an independent, dedicated battery 419. In the embodiment shown, the phase angle of the output AC voltage signal 485 of the first inverter 405 is set to zero degrees, the phase angle of the output AC voltage signal 490 of the second inverter 415 is set to 120 degrees, and the phase angle of the output voltage 492 of the third inverter 416 is set to 240 degrees. The S terminal 495, the R terminal 496, and a T terminal 497 may be used to provide a three-phase output voltage to power the three-phase AC load 305. Additionally, the neutral wire 418 may be used in combination with one of the S, R, or T terminals 495, 496, 497 to power the single-phase AC load 310. If the amplitude of the output voltages of the three phases are the same, the connected battery powered inverters 221 will yield a balanced three phase supply that eliminates circulating currents between the inverters 405, 415, 416. Additionally, the first inverter 405, the second inverter 415, and the third inverter 416 may be configured to communicate synchronization and fault coordination signals as previously described.

In the configuration shown, the output of one inverter can be used to charge the battery of one of the other inverters based on, for example, a state of charge of the other inverter's battery. For example, a controller of the first inverter 405 may receive data (e.g., from the sensors 226 or the controller 200) indicating that the battery 419 of the third inverter 416 needs to be charged. In response, the first inverter 406 may be configured to deliver a power signal via terminal R 496 to battery 419 for charging battery 419 until its state of charge matches that of the battery 410 of the first inverter 405. In some embodiments, the controller 200 determines that the batteries 410, 419, 420 have a charge imbalance and need to be charged to a similar state of charge to rebalance the system. In such embodiments, the controller 200 may direct a controller of each of the inverters 405, 415, 416 to cause the inverters 405, 415, 416 to charge at least one of the batteries 410, 419, 420 to a predetermined or rebalanced amount. In some embodiments, the first, second, and third inverters are bidirectional and their respective batteries can be charged simultaneously via the neutral wire 418 using a 3-phase power source.

By using connected battery powered inverters 221 including more than one inverter and one or more independent dedicated battery packs or batteries (e.g., 410, 419, 420) powering each inverter, multiple single-phase AC loads 310 having various power requirements can be served by each of the inverters (e.g., the first inverter 405, the second inverter 415, and the third inverter 416) simultaneously without causing ripple currents that would damage a battery pack shared by all of the inverters (e.g., the first inverter 405, the second inverter 415, and the third inverter 416). In some embodiments, the controller 200 is configured to manipulate one or more switches 498 (e.g., transistors, FETs, MOSFETs, relays, etc.) between the connected leads of the first inverter 405, the second inverter 415, and the third inverter 416 in order to reconfigure the connected battery powered inverters 221 into the open delta configuration shown in FIG. 4C. For example, switches 498 include field effect transistors (FETs) connected between an output lead of the inverters 405, 415, 416 and the neutral connection point 418. By opening the switch 498, between the third inverter 416 and the neutral wire 418, the first inverter 405 and second inverter 415 are connected in an open delta arrangement wherein the S terminal 495 is used as an input terminal of the open delta arrangement, and the R terminal 496 is used as an output terminal of the open delta arrangement.

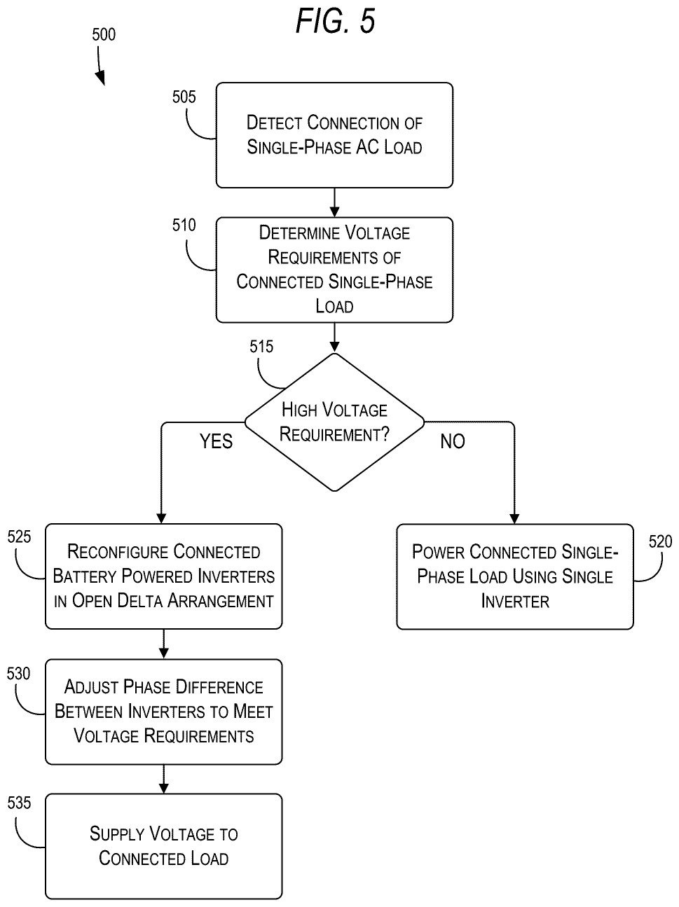

FIG. 5 is a flowchart 500 for reconfiguring connected battery powered inverters 221 from a wye configuration into an open delta configuration, and controlling the connected battery powered inverters 221 based on the voltage requirements of a connected single-phase AC load 310. At block 505, the controller 200 detects or determines that a single-phase AC load 310 is connected to the power supply 1.

At block 510, the controller 200 determines or receives an indication of a desired phase and voltage of output of the power supply (e.g., via user manipulation a switch of the power supply) For example, a user may manipulate controls (e.g., dials, switches, keypads, touchscreens) of the user interface 222 to indicate whether a single-phase or 3-phase output is desired, and to indicate a desired voltage level for the output.

At block 515, the controller 200 determines whether the desired output is a single-phase output having a high voltage requirement (e.g., higher than the voltage provided by a single inverter). For example, the controller 200 may determine that the desired output is a single-phase output having a voltage requirement that exceeds the voltage output capabilities of a single output terminal in the wye inverter configuration (e.g., using the neutral wire as a reference voltage). If the controller determines that the desired output does not have a high voltage requirement, the controller 200 proceeds to block 520. However, if the controller 200 determines that the desired output requires high voltage, the controller proceeds to block 525.

At block 520, the controller 200 causes one of the connected battery powered inverters to produce a single-phase power output signal for a connected single-phase AC load 310. For this non-high-voltage single-phase output, only one inverter may be sufficient for supplying the single-phase AC load with sufficient power. This single-phase power output signal may be further conditioned as needed by a power-conditioning circuit before reaching the connected single-phase AC load 310.

At block 525, the controller 200 controls the switches 498 to disconnect one of the first, second, or third inverters, 405, 415, 416, to reconfigure the three-phase wye connection power circuit to an open delta circuit. For example, the controller 200 may manipulate the switch 498 to disconnect the third inverter 416 from the first inverter 405 and the second inverter 415.

At block 530, the controller 200 adjusts the synchronization of the remaining two inverters (e.g., first and second inverters 405, 415) according to equation (2) to adjust the relative phase angles of the remaining inverters such that V_{AC} is sufficient for the voltage requirement of the connected single-phase AC load 310. The controller 200 may accomplish this synchronization adjustment by signaling one or both of the inverters (e.g., with a synchronization adjustment signal or with adjusted PWM signals).

At block 535, the connected battery powered inverters 221, now in the open delta configuration, supply the increased voltage to the connected single-phase AC load 310 via the terminals of the remaining inverters (e.g., terminals R 496 and S 495 of the first inverter 405 and the second inverter 415, respectively). This increased voltage signal may be further conditioned as needed by a power-conditioning circuit before reaching the connected single-phase AC load 310.

Thus, embodiments described herein provide, among other things, a reconfigurable, battery-powered multi-inverter circuit for a power supply. Various features and advantages are set forth in the following claims.

What is claimed is:

1. A power supply comprising:
an alternating-current (AC) output;
a first inverter configured to be powered by a first battery and to provide a first power signal having a first phase angle to the AC output;
a second inverter configured to be powered by a second battery and to provide a second power signal having a second phase angle to the AC output; and
a controller electrically connected to the first inverter and the second inverter and configured to:
control the first inverter to adjust the first phase angle and control the second inverter to adjust the second phase angle to adjust a magnitude of an output voltage at the AC output.

2. The power supply of claim 1, further including a user interface configured to allow a user to indicate a desired phase and output voltage for the power supply.

3. The power supply of claim 2, wherein the power supply is configured to produce the desired output voltage by adjusting a synchronization signal communicated between the first inverter and the second inverter to adjust a phase difference between the first angle and the second phase angle.

4. The power supply of claim 1, further including
a third inverter configured to be powered by a third battery and to provide a power signal having a third phase angle to the AC output; and,
a switching arrangement controlled by the controller and configured to switch the first inverter, the second inverter, and the third inverter between an open delta configuration including the first inverter and the second inverter, and a wye configuration including the first inverter, the second inverter, and the third inverter.

5. The power supply of claim 4, further comprising:
a neutral connection point, and
wherein in the wye configuration the neutral connection point connects the first inverter, the second inverter, and the third inverter.

6. The power supply of claim 5, wherein the first inverter, the second inverter, and the third inverter are configured to collectively power a 3-phase AC load in the wye configuration.

7. The power supply of claim 4, further comprising:
an alternating-current (AC) input,
wherein:
the first inverter, the second inverter, and the third inverter are bidirectional inverters and configured to receive an input power from the AC input; and
each of the first battery, the second battery, and the third battery is configured to be charged by one or more of the first inverter, the second inverter, and the third inverter from the AC input.

8. A power supply comprising:
an alternating-current (AC) output;
a first inverter configured to be powered by a first battery and to provide a first power signal to the AC output;
a second inverter configured to be powered by a second battery and to provide a second power signal to the AC output;
a third inverter configured to be powered by a third battery and to output a third power signal to the AC output;
a switching arrangement connected between the first inverter, the second inverter, and the third inverter; and
a controller electrically connected to the first inverter, the second inverter, and the third inverter and configured to:
control the switching arrangement to switch the first inverter, the second inverter, and the third inverter between an open delta configuration including the first inverter and the second inverter, and a wye configuration including the first inverter, the second inverter, and the third inverter.

9. The power supply of claim 8, wherein the first power signal has a first phase angle, the second power signal has a second phase angle, and the third power signal has a third phase angle.

10. The power supply of claim 9, wherein the first phase angle is 0 degrees, the second phase angle is 120 degrees, and the third phase angle is 240 degrees.

11. The power supply of claim 8, wherein the first inverter, second inverter, and third inverter are configured to operate independently of one another.

12. The power supply of claim 8, wherein the first inverter, the second inverter, and the third inverter are configured to collectively power a 3-phase AC load in the wye configuration.

13. The power supply of claim 8, further comprising:
a neutral connection point, and
wherein in the wye configuration the neutral connection point connects the first inverter, the second inverter, and the third inverter.

14. The power supply of claim 13, further comprising:
an alternating-current (AC) input,
wherein:
the first inverter, the second inverter, and the third inverter are bidirectional inverters and configured to receive an input power from the AC input; and
each of the first battery, the second battery, and the third battery is configured to be charged by one or more of the first inverter, the second inverter, and the third inverter from the AC input.

15. A method of controlling a power supply including a first inverter, a second inverter, and a third inverter connected to an alternating-current (AC) output, the method comprising:
determining, using a controller, an output requirement of the power supply;
connecting, using a switching arrangement, the first inverter and the second inverter in an open delta connection when the output requirement is a higher voltage; and
connecting, using the switching arrangement, the first inverter, the second inverter, the third inverter in a wye connection when the output requirement is a lower voltage.

16. The method of claim 15, wherein determining the output requirement includes receiving, via a user interface of the power supply, a desired phase and voltage.

17. The method of claim 15, further comprising:
adjusting a first phase angle of a first output signal of the first inverter and a second phase angle of a second output signal of the second inverter to control a magnitude of an output voltage at the AC output.

18. The method of claim 15, further comprising powering the first inverter, the second inverter, and the third inverter independently using a first battery, a second battery, and a third battery.

19. The method of claim 18, wherein the first inverter is a bidirectional inverter, the method further comprising:
receiving AC power at an AC input;
charging, using the first inverter, the second battery using the AC power received at the AC input.

20. The method of claim 15, further comprising operating the first inverter, second inverter, and third inverter independently of one another.
